(19) United States
(12) Patent Application Publication
(10) Pub. No.: US 2024/0410705 A1
(43) Pub. Date: Dec. 12, 2024

(54) PATH DETECTION USING MACHINE LEARNING MODELS FOR AUTONOMOUS SYSTEMS AND APPLICATIONS

(71) Applicant: NVIDIA Corporation, Santa Clara, CA (US)

(72) Inventors: Trung Pham, San Jose, CA (US); Minwoo Park, Saratoga, CA (US); Ha Giang Truong, Joondalup (AU); Atchuta Venkata Vijay Chintalapudi, Visakhapatnam (IN); Hae-Jong Seo, Campbell, CA (US)

(21) Appl. No.: 18/330,145

(22) Filed: Jun. 6, 2023

(51) Int. Cl. G01C 21/34; G06N 20/00

(52) U.S. Cl. CPC G01C 21/3446; G06N 20/00

(57) ABSTRACT

In various examples, path detection using machine learning models for autonomous or semi-autonomous systems and applications is described herein. Systems and methods are disclosed that use one or more machine learning models to determine a geometry associated with a path for a vehicle. To determine the geometry, the machine learning model(s) may process sensor data generated using the vehicle and, based at least on the processing, output points associated with the path. In some examples, the machine learning model(s) outputs a limited number of points, such as between five and twenty points. One or more algorithms, such as one or more Bezier algorithms, may then be used to generate the geometry based at least on the points. As such, in some examples, the geometry may correspond to a Bezier curve that represents the path.

### BACKGROUND

Designing a system to drive a vehicle autonomously without supervision at a level of safety required for practical acceptance is tremendously difficult. An autonomous vehicle should at least be capable of performing as a functional equivalent of an attentive driver-who draws upon a perception and action system that has an incredible ability to identify and react to dynamic and static obstacles in a complex environment—to avoid colliding with other objects or structures along its path. As such, among the most important tasks required of an autonomous system is determining drivable paths within complex environments that an autonomous vehicle may encounter. Because of this, numerous systems have been generated for determining these drivable paths for autonomous vehicles within environments.

For instance, some conventional systems for path detection rely on computer vision algorithms that use edge detection and manually engineered filters to identify lanes or lane markings. For example, computer vision algorithms may be used to rasterize images and assign pixels that correspond to lane markings as boundaries of a lane. In additional conventional systems, deep learning may be used to generate segmentation masks (e.g., that classify each pixel in an image), perform extensive post-processing on the segmentation masks to identify lane markings, and then assign the identified lane markings as boundaries of a lane.

However, these conventional approaches are limited to driving surfaces or environments that include visible lane markings (e.g., that have non-occluded lane markings). This limitation reduces or eliminates the effectiveness of these systems in environments where lane markings do not exist (e.g., unmarked roads), where lane markings are occluded (e.g., by debris, snow, other vehicles, etc.), and/or where lane markings are never present (e.g., within a cross-traffic intersection). In addition, because the output of these conventional systems requires substantial post-processing (e.g., filtering, smoothing, curve fitting, connected components labeling, etc.) to generate useable data (e.g., piecewise linear functions, arbitrary polygons, or clothoid curves), the run-time of the systems may be increased, and additional computing and processing requirements may be consumed-thereby reducing the efficiency of these conventional systems.

As a further example, some conventional systems may use deep learning to generate a polyline that represents a path for a vehicle. To generate the polyline, a large number of points that represent the polyline are determined using the deep learning, such as hundred and/or even thousands of points. However, based on the number of points, the polyline representation may be over-parameterized and/or inefficient. For instance, the over-parameterization may cause suboptimal path predictions, such that the path may be over complex compared to standard road construction designs, or may require a large number of network parameters, which may lower generalization capacity. Additionally, the polyline representation may increase the amount of compute required for temporal fusion and/or filtering due to the high dimensional state vector space.

### SUMMARY

Embodiments of the present disclosure relate to path detection using machine learning models for autonomous or semi-autonomous systems and applications. Systems and methods are disclosed that use one or more machine learning models to determine a geometry associated with a path for a vehicle. To determine the geometry, the machine learning model(s) may process sensor data generated or obtained using the vehicle and, based at least on the processing, output data indicative of points (e.g., control points, or locations thereof) associated with the path. In some examples, the machine learning model(s) outputs a limited number of points, such as between five and twenty points. One or more algorithms, such as one or more Bezier algorithms, may then be used to generate the geometry based at least on the points. As such, in some examples, the geometry may correspond to a Bezier curve that represents the path. Additionally, in some examples, the systems and methods may perform additional processing when generating the geometry associated with the path, such as filtering, smoothing (e.g., temporal and/or spatial), and/or so forth.

In contrast to conventional systems, such as the conventional systems that are limited to driving surfaces and/or environments that include visible lane markings, the current systems, in some embodiments, may use the machine learning model(s) that implements a deep learning solution (e.g., using a deep neural network (DNN), such as a convolutional neural network (CNN)), in order to create a more abstract definition of a drivable path that removes the reliance on explicit lane-markings. As such, the identification of drivable paths may be possible in environments where conventional approaches are unreliable or would otherwise fail-such as where lane markings do not exist or are occluded. Additionally, in contrast to these conventional systems, the current systems, in some embodiments, may use the machine learning model(s) to output drivable paths that may be useable by a vehicle with little to no post-processing. As a direct result, and compared to these conventional systems, substantial computing power may be saved and processing requirements may be reduced-thereby speeding up run-time to allow for real-time or near real-time deployment while simultaneously reducing the overall burden on the system.

Furthermore, in contrast to conventional systems, such as conventional systems that use deep learning to generate polylines for drivable paths, the current systems, in some embodiments, may use the machine learning model(s) that outputs less points (e.g., between five and twenty points) as compared to those conventional systems which may output a large number of points (e.g., hundred or thousands of points). Generating drivable paths using less points may reduce the number of parameters associated with the machine learning model(s) and/or reduce the runtime required to generate the drivable paths. Additionally, generating drivable paths using less points may output smoother drivable paths and/or drivable paths that better represent the driving surfaces.

### BRIEF DESCRIPTION OF THE DRAWINGS

The present systems and methods for path detection using machine learning models for autonomous and semi-autonomous systems and applications are described in detail below with reference to the attached drawing figures, wherein:

FIG. 1 illustrates an example data flow diagram for a process of using one or more machine learning models to determine geometries associated with paths, in accordance with some embodiments of the present disclosure;

FIG. 2 illustrates an example of generating a Bezier curve associated with a path, in accordance with some embodiments of the present disclosure;

FIG. 3 illustrates an example of determining paths associated with two-dimensional (2D) image space and three-dimensional (3D) world space, in accordance with some embodiments of the present disclosure;

FIGS. 4A-4B illustrate examples of machine learning models that are configured to determine geometries associated with paths, in accordance with some embodiments of the present disclosure;

FIG. 5 is a data flow diagram illustrating a process for training one or more machine learning model(s) to generate geometries associated with paths, in accordance with some embodiments of the present disclosure;

FIGS. 6A-6B illustrate examples of ground truth data representing geometries associated with paths, in accordance with some embodiments of the present disclosure;

FIGS. 7A-7B illustrate examples of ground truth data representing points associated with paths, in accordance with some embodiments of the present disclosure;

FIG. 8 illustrates a flow diagram showing a method for determining a Bezier curve associated with a path of a machine, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

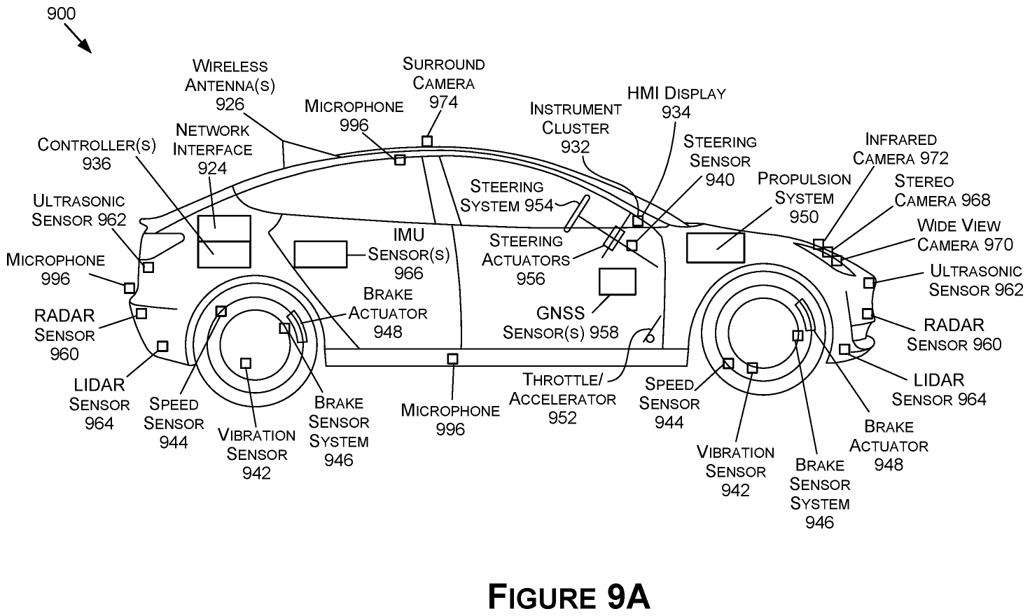

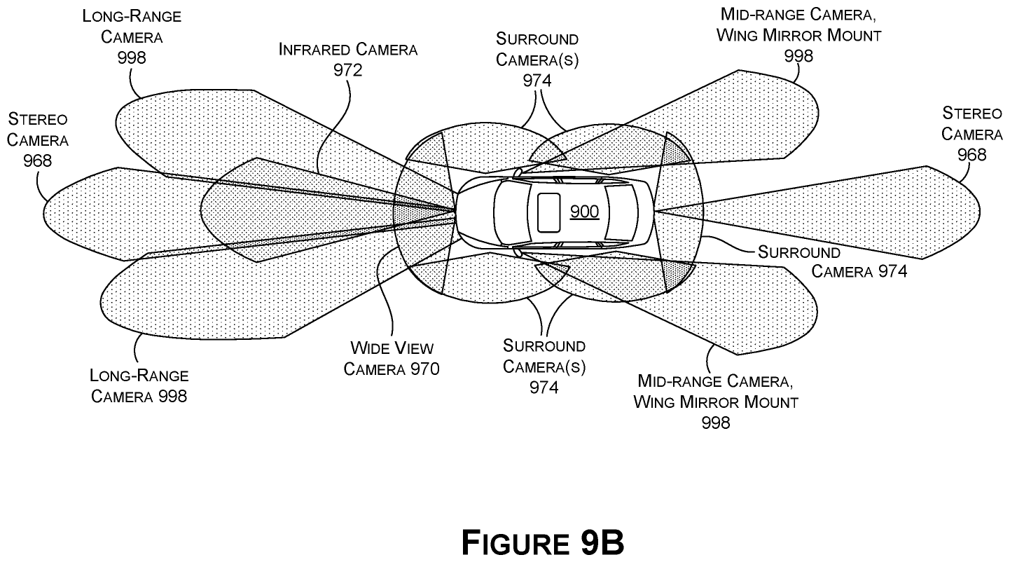

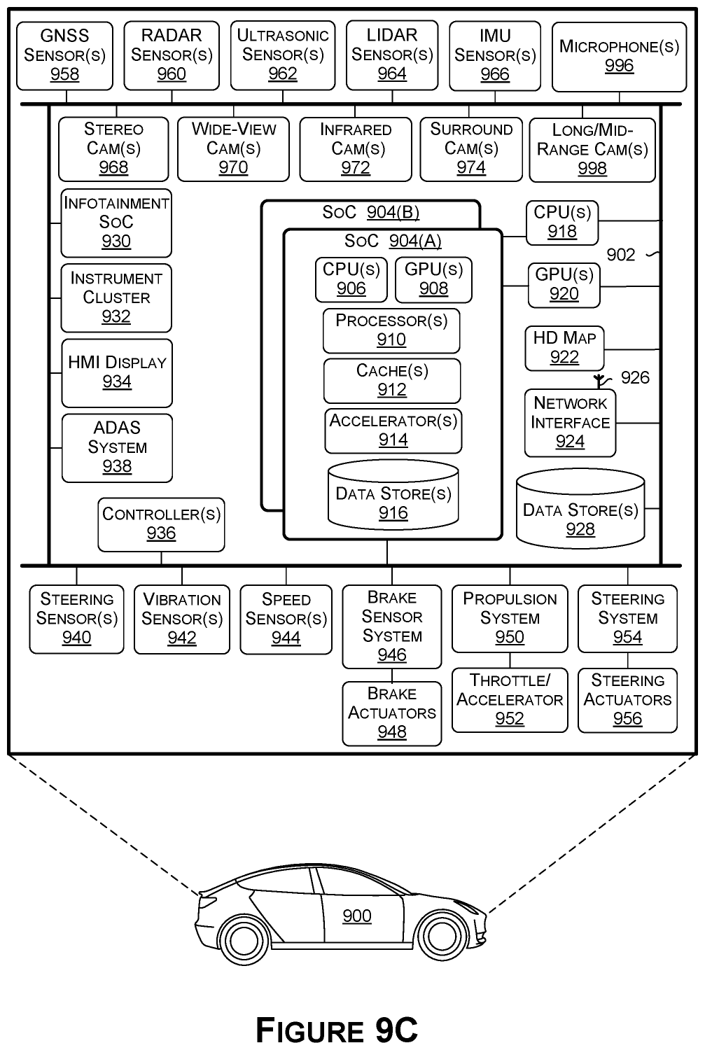

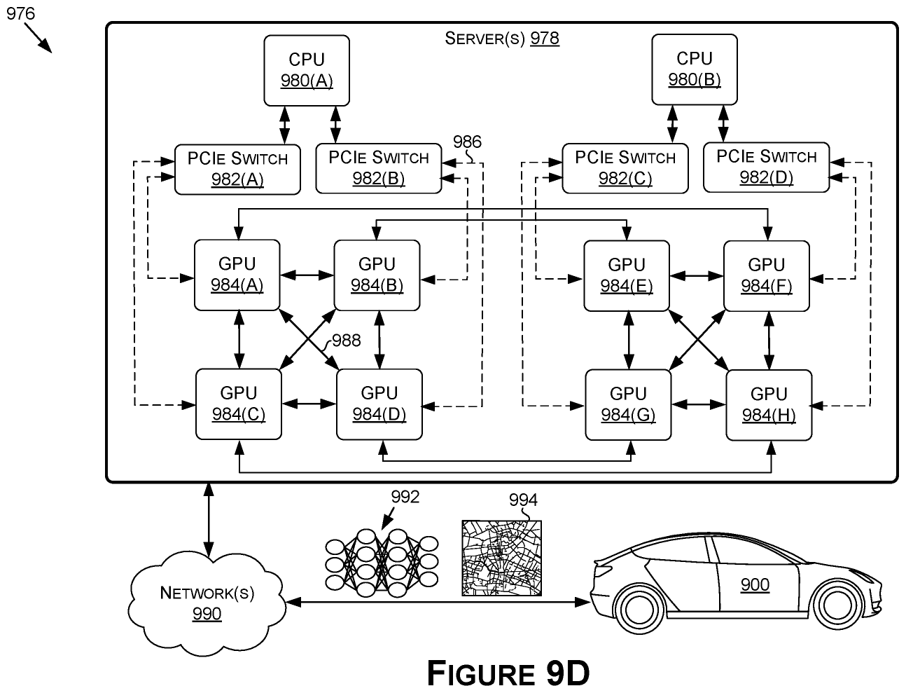

Systems and methods are disclosed related to path detection for machine learning models for autonomous and semi-autonomous systems and applications. Although the present disclosure may be described with respect to an example autonomous vehicle 900 (alternatively referred to herein as “vehicle 900” or “ego-machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to path detection for autonomous or semi-autonomous machine applications, this is not intended to be limiting, and the systems and methods described herein may be used in augmented reality, virtual reality, mixed reality, robotics, security and surveillance, autonomous or semi-autonomous machine applications, and/or any other technology spaces where path detection may be used.

For instance, a system(s) may receive sensor data generated using one or more sensors associated with a vehicle (e.g., a machine), such as a semi-autonomous and/or autonomous vehicle. As described herein, in some examples, the sensor data may include image data generated using one or more image sensors, such as one or more cameras of the vehicle, or may include LiDAR data, RADAR data, ultrasonic data, and/or other data types generated using any number of sensor modalities. For example, where image data is used, the image data may be generated using a front-facing image sensor(s) of the vehicle, where the image data represents one or more images depicting an environment in front of the vehicle and/or in a direction that the vehicle is substantially navigating. In some examples, the system(s) may then process the sensor data using one or more processing techniques, which are described in more detail herein.

The system(s) may then input the sensor data (and/or the processing sensor data) into one or more machine learning models that are configured to generate data associated with one or more paths for the vehicle to navigate. For instance, based at least on processing the sensor data (and/or the processed sensor data), the machine learning model(s) may generate a first output indicating points (e.g., Bezier points, or control points) associated with one or more paths. As described herein, the one or more paths may include, but are not limited to, a first path that the vehicle is to navigate, one or more second paths that are adjacent to the first path (e.g., one or more paths that are to the left of the first path and/or one or more paths that are to the right of the first path), and/or one or more other paths, such as an exit path, a merge path, a lane split path, a path of opposing traffic, and/or so forth. Additionally, for a path, the first output may include any number of points such as, but not limited to, two points, five points, eight points, twelve points, twenty points, fifty points, and/or any other number of points. As described herein, in some examples, such as to reduce the computing resources needed to generate the path(s) and/or to reduce the latency in generating the path(s), the number of points for a path may be limited to a threshold number of points and/or a threshold number of points per distance of the path.

Additionally, in some examples, based at least on processing the sensor data (and/or the processed sensor data), the machine learning model(s) may generate a second output indicating one or more classifications associated with the points and/or the path(s). As described herein, a classification may include, but is not limited to, a vehicle or ego path (e.g., the path that the vehicle is to navigate), an adjacent path, a left-adjacent path, a right-adjacent path, an edge path, a left-edge path, a right-edge path, an exit path, a merge path, a lane split path, an opposing traffic path, and/or any other type of path. In some examples, the second output may indicate a respective classification for each point and/or each path. Additionally, or alternatively, in some examples, the second output may indicate one or more probabilities associated with one or more classifications for each point and/or each path.

The system(s) (e.g., the machine learning model(s), one or more postprocessing components, etc.) may then use the first output to generate one or more geometries associated with the path(s). For example, and for a path, the system(s) may use one or more algorithms to generate a curve, such as a Bezier curve, based at least on the points associated with the path. As described herein, in some examples, an algorithm may include a Bezier algorithm such as, but not limited to, a two-dimensional Bezier curve fitting algorithm, a three-dimensional Bezier curve fitting algorithm, a cubic Bezier curve fitting algorithm, a higher order Bezier curve fitting algorithm, a split wise Bezier curve fitting algorithm, and/or any other type of Bezier algorithm. Additionally, or alternatively, in some examples, an algorithm may include another type of curve-fitting algorithm that is configured to generate a curve based at least on the points associated with the path. The system(s) may then use similar processes to generate a respective curve associated with one or more (e.g., each) of the other path(s).

In some examples, the system(s) (e.g., the machine learning model(s), the postprocessing component(s), etc.) may perform one or more additional processing techniques when generating the one or more geometries associated with the path(s). For example, and for a path, the system(s) may perform one or more smoothing techniques in order to smooth the geometry associated with the path, one or more temporal fusion or smoothing techniques (e.g., using a Kalman Filter for temporal fusion) in order to improve the temporal robustness of the geometry associated with the path, and/or so forth. The system(s) may then perform similar processing with respect to one or more other geometries (e.g., each geometry) associated with one or more of the other path(s) (e.g., each path).

The system(s) may perform one or more different processes for training the machine learning model(s) to determine the points associated with the paths, determine the geometries associated with the paths, and/or determine the classifications associated with the paths. For a first example, the system(s) may train the machine learning model(s) using first training sensor data and corresponding first ground truth data, where the first ground truth data represents geometries (e.g., curves) associated with paths. In such an example, the system(s) may use the machine learning model(s) to generate, based at least on the first training sensor data and using one or more of the processes described herein, predicted geometries associated with the paths. The system(s) may then determine losses based at least on the geometries represented by the first ground truth data and the predicted geometries. Additionally, the system(s) may use the losses to train (e.g., update one or more parameters—e.g., weights and/or one biases of) the machine learning model(s).

For a second example, the system(s) may train the machine learning model(s) using second training sensor data and corresponding second ground truth data, where the second ground truth data represents locations of points associated with paths. In such an example, the second ground truth data may be generated by converting the geometries represented by the first ground truth data using one or more techniques, such as iterative least square fitting. The system(s) may use the machine learning model(s) to generate, based at least on the second training sensor data and using one or more of the processes described herein, predicted locations of the points associated with the paths. The system(s) may then determine losses based at least on the locations of the points as represented by the second ground truth data and the predicted locations of the points. Additionally, the system(s) may use the losses to train (e.g., update one or more parameters—e.g., biases and/or one or more weights of) the machine learning model(s).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems implementing language models-such as large language models (LLMs) that process textual, audio, image, sensor, and/or other data types to generate one or more outputs, systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

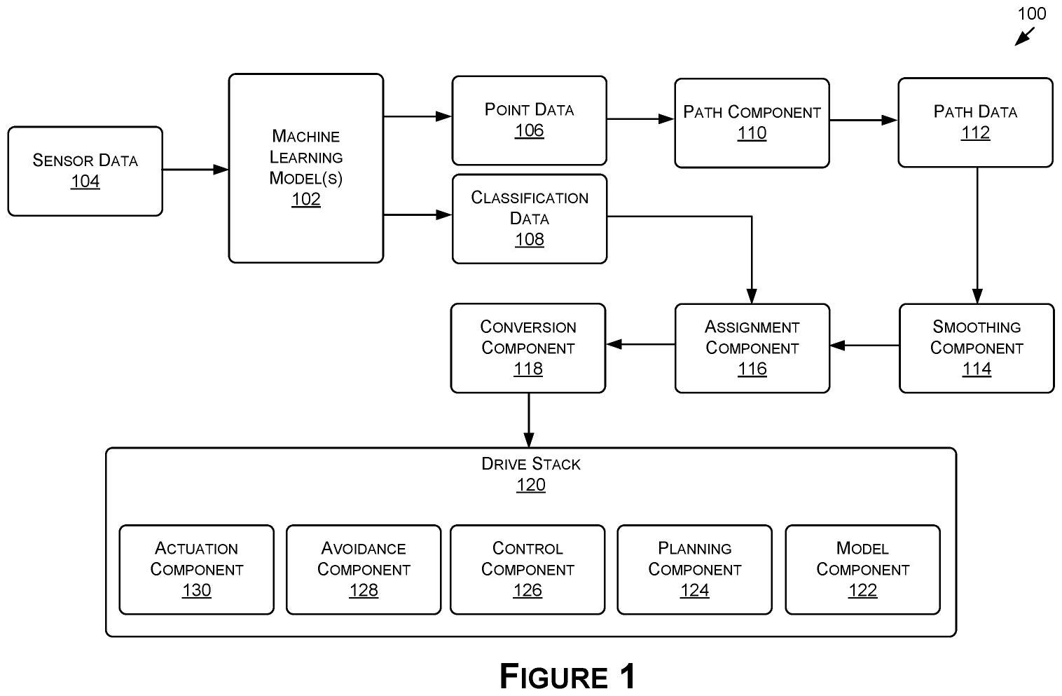

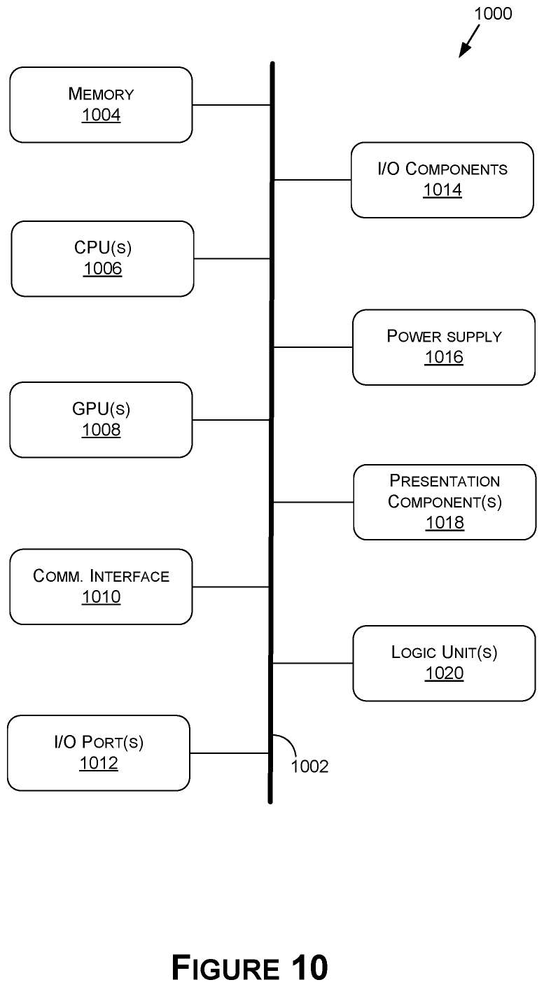

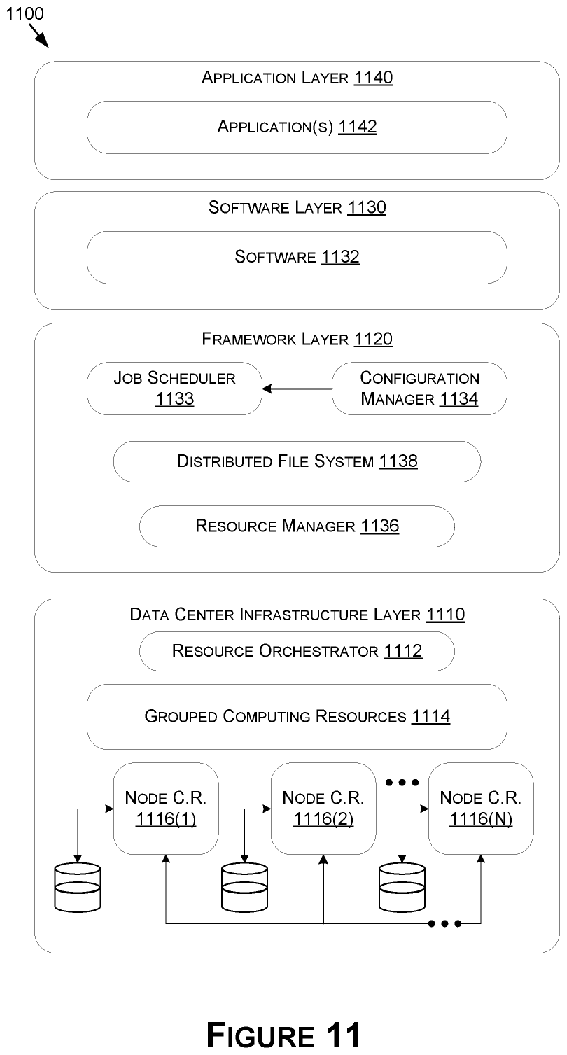

With reference to FIG. 1, FIG. 1 illustrates an example data flow diagram for a process 100 of using one or more machine learning models 102 to determine geometries associated with paths, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

The process 100 may include the machine learning model(s) 102 receiving one or more inputs, such as sensor data 104, and generating one or more outputs, such as path data 106 representing points associated with one or more paths and/or classification data 108 representing one or more classifications associated with the path(s). In some examples, the sensor data 104 may include image data generated using one or more image sensors (e.g., one or more cameras) of a vehicle. In some examples, the sensor data 104 may additionally or alternatively include other types of senor data, such as LiDAR data generated using one or more LiDAR sensors, RADAR data generated using one or more RADAR sensors, and/or so forth.

In examples where the sensor data 104 includes image data, the image data may include data representative of images of a field of view of one or more image sensors of the vehicle, such as stereo camera(s), wide-view camera(s) (e.g., fisheye cameras), infrared camera(s), surround camera(s) (e.g., 360 degree cameras), long-range and/or mid-range camera(s), and/or other camera type of the vehicle. In some examples, the image data may be captured by a single image sensor with a forward-facing, substantially centered field of view with respect to a horizontal axis (e.g., left to right) of the vehicle. The image data captured from this perspective may be useful for perception when navigating—e.g., within a lane, through a lane change, through a turn, through an intersection, etc.—because a forward-facing image sensor may include a field of view that includes both a current lane of travel of the vehicle, an adjacent lane(s) of travel of the vehicle, and/or boundaries of the driving surface. In some examples, more than one image sensor or other types of sensors (e.g., LiDAR sensor, RADAR sensor, etc.) may be used to incorporate multiple fields of view.

In some examples, the image data may be captured in one format (e.g., RCCB, RCCC, RBGC, etc.) and then converted (e.g., during pre-processing of the image data) to another format. In some examples, the image data may be provided as input to a sensor data pre-processor (not shown) to generate pre-processed image data. Many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format such as H.264/Advanced Video Coding (AVC) or H.265/High Efficiency Video Coding (HEVC), raw images such as originating from Red Clear Blue (RCCB), Red Clear (RCCC) or other type of imaging sensor. In some examples, different formats and/or resolutions may be used for training the machine learning model(s) 102 than for inferencing (e.g., during deployment of the machine learning model(s) 102 in the vehicle).

The sensor data pre-processor may use image data representative of one or more images (or other data representations) and load the sensor data 104 into memory in the form of a multi-dimensional array/matrix (alternatively referred to as tensor, or more specifically an input tensor, in some examples). The array size may be computed and/or represented as W×H×C, where W stands for the image width in pixels, H stands for the height in pixels, and C stands for the number of color channels. Without loss of generality, other types and orderings of input image components are also possible. Additionally, the batch size B may be used as a dimension (e.g., an additional fourth dimension) when batching is used. Batching may be used for training and/or for inference. Thus, the input tensor may represent an array of dimension W×H×C×B. Any ordering of the dimensions may be possible, which may depend on the particular hardware and software used to implement the sensor data pre-processor. This ordering may be chosen to maximize training and/or inference performance of the machine learning model(s) 102.

In some examples, a pre-processing image pipeline may be employed by the sensor data pre-processor to process a raw image(s) acquired by a sensor(s) (e.g., an image sensor(s)) and included in the image data to produce pre-processed image data which may represent an input image(s) to an input layer(s) (e.g., a feature extractor layer(s)) of the machine learning model(s) 102. An example of a suitable pre-processing image pipeline may use a raw RCCB Bayer (e.g., 1-channel) type of image from the sensor and convert that image to a RCB (e.g., 3-channel) planar image stored in Fixed Precision (e.g., 16-bit-per-channel) format. The pre-processing image pipeline may include decompanding, noise reduction, demosaicing, white balancing, histogram computing, and/or adaptive global tone mapping (e.g., in that order, or in an alternative order).

Where noise reduction is employed by the sensor data pre-processor, it may include bilateral denoising in the Bayer domain. Where demosaicing is employed by the sensor data pre-processor, it may include bilinear interpolation. Where histogram computing is employed by the sensor data pre-processor, it may involve computing a histogram for the C channel, and may be merged with the decompanding or noise reduction in some examples. Where adaptive global tone mapping is employed by the sensor data pre-processor, it may include performing an adaptive gamma-log transform. This may include calculating a histogram, getting a mid-tone level, and/or estimating a maximum luminance with the mid-tone level.

The machine learning model(s) 102 may use as input one or more images or other data representations (e.g., LiDAR data, RADAR data, etc.) as represented by the sensor data 104 to generate the output(s). In some examples, the machine learning model(s) 102 may take, as input, an image(s) represented by the sensor data 104 (e.g., after pre-processing) to generate the point data 106 and/or the classification data 108. Although examples are described herein with respect to using neural networks, and specifically CNNs, as the machine learning model(s) 102, this is not intended to be limiting. For example, and without limitation, the machine learning model(s) 102 described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

The point data 106 may represent points (e.g., control or Bezier points) for one or more paths associated with the vehicle. In some examples, the one or more paths may include, but are not limited to, a first path that the vehicle is to navigate (e.g., an ego path), one or more second paths that are adjacent to the first path (e.g., one or more paths that are to the left of the ego path and/or one or more paths that are to the right of the ego path), and/or one or more other paths, such as an exit path, a merge path, a lane split path, a path of opposing traffic, and/or so forth. Additionally, for a path, the first output may include any number of points such as, but not limited to, two points, five points, eight points, twelve points, twenty points, fifty points, and/or any other number of points. As described herein, in some examples, such as to reduce the computing resources needed to generate the path(s) and/or to reduce the latency in generating the path(s), the number of points for a path may be limited by a threshold number of points (e.g., ten points, twelve points, fifteen points, twenty points, etc.) and/or a threshold number of points per distance associated with the path (e.g., twelve points per one hundred meters of path).

The point data 106 may represent locations associated with the points, where the locations may include one or more various types of locations. For instance, in some examples, the locations associated with the points may include three-dimensional (3D) locations, such as x-coordinate locations, y-coordinate locations, and z-coordinate locations within world space. In such examples, the 3D locations may be relative to a given location, such as the vehicle and/or the sensor(s) that was used to generate the sensor data 104. Additionally, or alternatively, in some examples, the locations associated with the points may include two-dimensional (2D) locations, such as 2D locations relative to the vehicle and/or the sensor(s) that was used to generate the sensor data 104. Additionally, or alternatively, in some examples, the locations associated with the points may correspond to locations represented by the sensor representation associated with the sensor data 104. For example, if the sensor data 104 includes image data representing an image, then the locations may include pixel locations associated with the image.

Still, in some examples, the locations associated with the points may include delta values. In such examples, the delta values may represent distances, such as pixel distances, in any direction (e.g., the x-direction, the y-direction, etc.) with respect to an anchor point (e.g., predetermined, fixed anchor points distributed at points in a camera frame, LiDAR frame, etc.), or with respect to anchor points of an anchor line (e.g., a line having one or more anchor points along it). For example, the machine learning model(s) 102 may be trained to predict delta values that correspond to locations (e.g., represented as distances from anchor points) of points associated with an edge or rail (e.g., center) of a drivable path. For a given anchor point, the machine learning model(s) 102 may output a series of delta values for one or more points (e.g., each point) associated with a path. Because the pixel coordinates or locations of the anchor points or anchor lines may be known by a path detection system (e.g., a path component 110), the delta values may be used to identify the pixel coordinates or locations corresponding to the points.

The classification data 108 may represent one or more classifications associated with one or more of the points and/or one or more of the path(s). As described herein, the one or more paths may include, but are not limited to, a first (e.g., ego) path that the vehicle is to navigate, one or more second paths that are adjacent to the first path (e.g., one or more paths that are to the left of the first path and/or one or more paths that are to the right of the first path), and/or one or more other paths, such as an exit path, a merge path, a lane split path, a path of opposing traffic, and/or so forth. In some examples, the classification data 108 may output one or more confidence values associated with the classification(s). For instance, for a point and/or a path, confidence values may be output for one or more (e.g., each) classification that the machine learning model(s) 102 is trained to predict. For example, if the machine learning model(s) 102 is trained to predict three types of classifications associated with paths, the classification data 108 may represent an array including confidence values for each of the three classifications for the point and/or the path. As described in more detail herein, the confidence values may then be used to select a final classification associated with the point and/or the path.

As further illustrated in the example of FIG. 1, the process 100 may include a path component 110 processing the point data 106 and, based at least on the processing, generating path data 112 representing one or more paths. While the example of FIG. 1 illustrates the path component as being separate from the machine learning model(s) 102, in other examples, the path component 110 may be included as part of the machine learning model(s) 102. For example, the path component 110 may correspond to one or more layers of the machine learning model(s) 102 that are trained to perform one or more of the processes described herein with respect to the path component 110. In such examples, the machine learning model(s) 102 may be configured to output the path data 112 in addition to, or alternatively from, outputting the point data 106.

The path component 110 may be configured to use the points, represented by the point data 106, to generate one or more geometries representing the path(s). For example, and for a path, the path component 110 may use one or more algorithms to generate a curve, such as a Bezier curve, based at least on the points associated with the path. As described herein, in some examples, an algorithm may include a Bezier algorithm such as, but not limited to, a two-dimensional Bezier curve fitting algorithm, a three-dimensional Bezier curve fitting algorithm, a cubic Bezier curve fitting algorithm, a higher order Bezier curve fitting algorithm, a split wise Bezier curve fitting algorithm, and/or any other type of Bezier algorithm. Additionally, or alternatively, in some examples, an algorithm may include another type of algorithm that is configured to generate a curve based at least on the points associated with the path. The path component 110 may then use similar processes to generate a respective curve associated with one or more (e.g., each) of the other path(s).

For an example of generating a curve (e.g., a geometry) associated with a path, given a set of n+1 points associated with the path, a curve may be generated by the following equation:

$$B ( t ) = {\sum }_{i = 0}^{n} {B}_{i}^{n} ( t ) {P}_{i} \qquad ( 1 )$$

In equation (1), t is a value between 0 to 1 that determines the position along the curve, Pᵢ is the i-th point, and Br are the Bernstein polynomials of degree n such that:

$${B}_{i}^{n} ( t ) = ( \begin{matrix}n \\ i\end{matrix} ) {{t}^{i} ( 1 - t )}^{n - i} \qquad ( 2 )$$

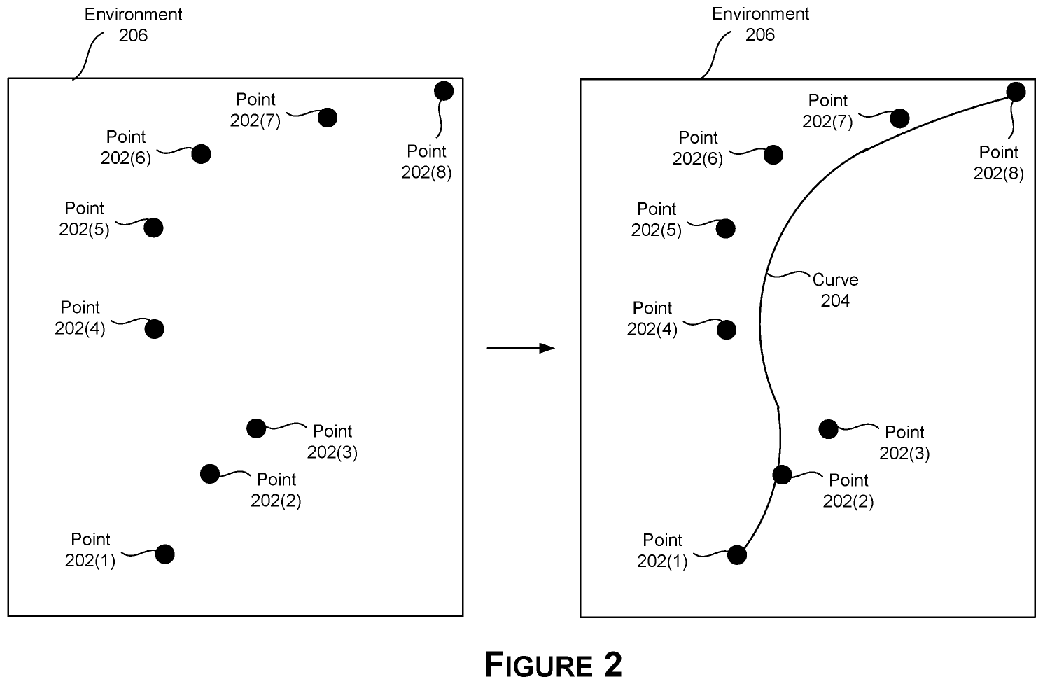

For instance, FIG. 2 illustrates an example of generating a Bezier curve associated with a path using points 208(1)-(8) (also referred to singularly as “point 208” or in plural as “points 208”), in accordance with some embodiments of the present disclosure. In the example of FIG. 2, the machine learning model(s) 102 may have processed sensor data (e.g., the sensor data 104) in order to determine the points 208 associated with the path. While the example of FIG. 2 illustrates the machine learning model(s) 102 as determining eight points 208 associated with the path, in other examples, the machine learning model(s) 102 may perform similar processes to determine any number of points associated with the path.

The path component 110 may then perform one or more of the processes described herein, such as using one or more Bezier algorithms, to determine a curve 204 (e.g., a geometry, such as a Bezier curve) associated with the path. As shown, by using the Bezier algorithm(s), the curve 204 may start at a first point 202(1), end at a last point 202(8), and include a shape that is based at least on the other points 202(2)-(7). Additionally, by using the Bezier algorithm(s), the curve 204 may include a smooth, continuous curve that is intended to represent the actual path that the vehicle is to follow within an environment 206.

Referring back to the example of FIG. 1, the process 100 may include a smoothing component 114 that processes the path data 112 in order to smooth one or more of the path(s). For instance, temporal smoothing may be used to improve stability at further distances, to reduce flickering of paths under sudden exposure changes, and/or otherwise to smooth and reduce noise in the output of the machine learning model(s) 102 and/or the path component 110. For instance, in some examples, values (e.g., point locations, path geometry(ies), etc.) computed by the machine learning model(s) 102 and/or the path component 110 for a current instance of the sensor data 104 may be weighed against values (e.g., point locations, path geometry(ies), etc.) computed by the machine learning model(s) 102 and/or the path component 110 for one or more prior instances of the sensor data 104. Where the sensor data 104 is image data representative of images, for example, the path geometry(ies) for a current or most recent image may be weighed against the path geometry(ies) for one or more previous images. As such, the smoothing component 114 may perform temporal smoothing using the following equation:

$$final\_value = a * {value\_image}_{previous} + ( 1 - a ) * {value\_image}_{current} \qquad ( 3 )$$

In equation (3), a is a weighting factor, final_value is a value of a path geometry after temporal smoothing, value_imageₚᵣₑᵥᵢₒᵤₛ is a value computed for a path geometry by the machine learning model(s) 102 and/or the path component 110 for a previous frame(s), and value_image_{current} is a value computed for a path geometry by the machine learning model(s) 102 and/or the path component 110 for a current frame.

The process 100 may include an assignment component 116 that is configured to associate one or more of the path(s) with one or more classifications represented by the classification data 108. In some examples, the assignment component 116 may use an ArgMax function (e.g., a winner-take-all approach), where a path associated with a highest confidence value for a classification may be selected as the path for that path type with respect to the current instance of the sensor data 104 (e.g., a current frame of image data).

As such, in an example where there are three paths determined by the machine learning model(s) 102 and/or the path component 110, and three different classifications, there may be three confidence values corresponding to the likelihood that a path corresponds to each of the classifications. For instance, a path may be associated with a first confidence value that the path is associated with a first classification (e.g., a vehicle path), a second confidence value that the path is associated with a second classification (e.g., a right-adjacent path), and a third confidence value that the path is associated with a third classification (e.g., a left-adjacent path). The assignment component 116 may then determine that the path is associated with the first classification when the first confidence value includes a highest confidence value. Additionally, the assignment component 116 may perform similar processes for each of the other two paths in this example.

In some examples, the assignment component 116 may be executed using non-maximum suppression. Non-maximum suppression may be used where two or more paths have associated confidence values (e.g., corresponding to the path classification(s)) that indicate the paths may correspond to the same path classification. In such examples, the confidence value that is the highest for the particular path classification may be used to determine the path for the path type, and non-maximum suppression may be used to remove, or suppress, the other paths. To determine which paths to suppress, a calculation may be made of the sum distance between paths of the same path type, where the sum distance may be calculated by summing the distances between a number of points along the different paths (e.g., along a selected path and along each other path of one or more other paths). The points may be selected at the same number of arc lengths along the paths, and a distance may be calculated between points on the selected path and points on the other paths. Where the sum distances are low enough (e.g., within a threshold sum distance), the path may be determined to be duplicative, and the path(s) may be suppressed. As a result, only one path geometry may remain for each path classification.

The process 100 may include using a conversion component 118 that is configured to convert the points and/or paths from a first coordinate system to a second coordinate system. For instance, and as described herein, the locations associated with the points and/or the paths may be associated with a sensor representation represented by the sensor data 104. For example, if the sensor data 104 represents an image, the locations of the points and/or the locations of the vertices of the paths may be determined in 2D image space. As such, once the locations of the points and/or the locations of the vertices of the path(s) are determined in 2D image space, the conversion component 118 may perform 2D to 3D conversion in order to determine the locations of the points and/or the locations of the vertices of the path(s) in world space.

For more detail, the pixel locations may be 2D coordinates in the image (e.g., a column and a row). In order to accurately determine the relationship between the 2D coordinates and the 3D world-space coordinates, 3D to 2D projection may be used. For example, an image sensor or other sensor(s) may be calibrated using one or more intrinsic (e.g., focal length, f, optical center (uₒ, vₒ), pixel aspect ratio, α, skew, s, etc.) and/or extrinsic (e.g., 3D rotation, R, translation, t, etc.) parameters. One or more constraints may also be imposed, such as requiring that the 3D point always lies on the ground plane of the driving surface. In some examples, one or more of the parameters of the image sensor may be dynamic (e.g., due to vibration, movement, orientation, etc.), and the 3D to 2D projection may be dynamically updated as a result. In some examples, such as where two or more cameras are used, stereo vision techniques may be used to determine a correlation between 2D points and 3D world-space locations. In any example, the 3D world-space coordinates may then be mapped to the 2D coordinates of the pixels in the image space, such that when the vertex locations, or the path locations, are determined, the 3D world-space coordinates are known and may be used by the vehicle.

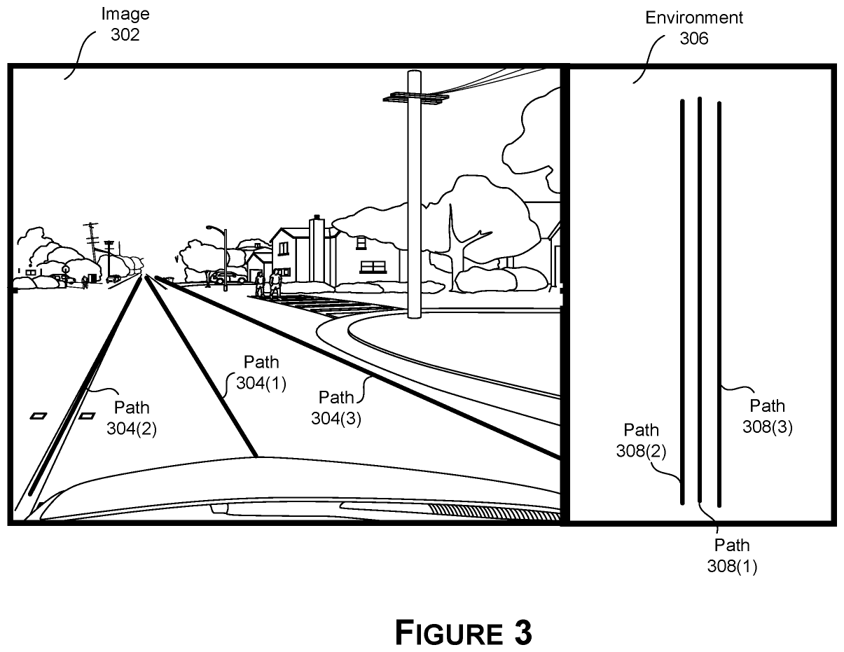

For instance, FIG. 3 illustrates an example of determining paths associated with two-dimensional (2D) image space and three-dimensional (3D) world space, in accordance with some embodiments of the present disclosure. As shown, in image space 302, the vehicle may determine at least a first path 304(1), a second path 304(2), and a third path 304(3) using one or more of the processes described herein. While the example of FIG. 3 illustrates the vehicle as determining three paths 304(1)-(3), in other examples, the vehicle may determine any number of paths (e.g., one path, two paths, five paths, seven paths, ten paths, etc.). Additionally, in the example of FIG. 3, the first path 304(1) may include a current path of the vehicle, the second path 304(2) may include a left-adjacent path to the first path 304(1), and the third path 304(3) may include a right-adjacent path to the first path 304(1).

The vehicle may then perform one or more of the processes described herein to convert the 2D coordinates associated with the image space 302 to 3D coordinates associated with the world space corresponding to an environment 306 depicted by the image 302. For instance, and as shown, the vehicle may perform one or more of the processes described herein to determine coordinates for a first path 308(1) that corresponds to the first path 304(1), determine coordinates for a second path 308(2) that corresponds to the second path 304(2), and determine coordinates for a third path 308(3) that corresponds to the third path 304(3). As shown, the geometries associated with the paths 308(1)-(3) are substantially similar to one another.

Referring back to the example of FIG. 1, the process 100 may include a drive stack 120 that uses the determined path(s) in order to cause the vehicle to perform one or more operations. As shown, the drive stack 122 may include a sensor manager (not shown), one or more perception components (e.g., corresponding to a perception layer of the drive stack 120), a world model manager 122, one or more planning components 124 (e.g., corresponding to a planning layer of the drive stack 120), one or more control components 126 (e.g., corresponding to a control layer of the drive stack 120), one or more obstacle avoidance components 128 (e.g., corresponding to an obstacle or collision avoidance layer of the drive stack 120), one or more actuation components 130 (e.g., corresponding to an actuation layer of the drive stack 120), and/or other components corresponding to additional and/or alternative layers of the drive stack 120. The process 100 may, in some examples, be executed by the perception component(s), which may feed up the layers of the drive stack 120 to the world model manager, as described in more detail herein.

The sensor manager may receive the sensor data 104 from the sensors in different formats (e.g., sensors of the same type, such as image sensors of cameras, may output sensor data in different formats), and may be configured to convert the different formats to a uniform format (e.g., for each sensor of the same type). As a result, other components, features, and/or functionality of the vehicle may use the uniform format, thereby simplifying processing of the sensor data 104. In some examples, the sensor manager may use a uniform format to apply control back to the sensors of the vehicle, such as to set frame rates or to perform gain control. The sensor manager may also update sensor packets or communications corresponding to the sensor data 104 with timestamps to help inform processing of the sensor data 104 by various components, features, and functionality of an autonomous vehicle control system.

The world model manager 122 may be used to generate, update, and/or define a world model. The world model manager 122 may use information generated by and received from the perception component(s) of the drive stack 120 (e.g., the locations of the rails or edges of drivable paths based on the path geometry(ies), the path classification(s), etc.). The perception component(s) may include an obstacle perceiver, a path perceiver, a wait perceiver, a map perceiver, and/or other perception component(s). For example, the world model may be defined, at least in part, based on affordances for obstacles, paths, and wait conditions that can be perceived in real-time or near real-time by the obstacle perceiver, the path perceiver, the wait perceiver, and/or the map perceiver. The world model manager 122 may continually update the world model based on newly generated and/or received inputs (e.g., data) from the obstacle perceiver, the path perceiver, the wait perceiver, the map perceiver, and/or other components of the autonomous vehicle control system.

The world model may be used to help inform the planning component(s) 124, the control component(s) 126, the obstacle avoidance component(s) 128, and/or the actuation component(s) 130 of the drive stack 120. The obstacle perceiver may perform obstacle perception that may be based on where the vehicle is allowed to drive or is capable of driving (e.g., based on the location of the drivable paths defined by the path geometry(ies)), and how fast the vehicle can drive without colliding with an obstacle (e.g., an object, such as a structure, entity, vehicle, etc.) that is sensed by the sensors of the vehicle.

The path perceiver may perform path perception, such as by perceiving nominal paths that are available in a particular situation. In some examples, the path perceiver may further take into account lane changes for path perception. A lane graph may represent the path or paths available to the vehicle, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information.

The wait perceiver may be responsible to determining constraints on the vehicle as a result of rules, conventions, and/or practical considerations. For example, the rules, conventions, and/or practical considerations may be in relation to traffic lights, multi-way stops, yields, merges, toll booths, gates, police or other emergency personnel, road workers, stopped buses or other vehicles, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle of static or stationary infrastructure objects and obstacles. The map perceiver may also generate information for the wait perceiver and/or the path perceiver, for example, such as to determine which light at an intersection has to be green for the vehicle to take a particular path.

In some examples, information from the map perceiver may be sent, transmitted, and/or provided to a server(s) (e.g., to a map manager of the server(s)), and information from the server(s) may be sent, transmitted, and/or provided to the map perceiver and/or a localization manager of the vehicle. The map manager may include a cloud mapping application that is remotely located from the vehicle and accessible by the vehicle over one or more network(s). For example, the map perceiver and/or the localization manager of the vehicle may communicate with the map manager and/or one or more other components or features of the server(s) to inform the map perceiver and/or the localization manager of past and present drives or trips of the vehicle, as well as past and present drives or trips of other vehicles. The map manager may provide mapping outputs (e.g., map data) that may be localized by the localization manager based on a particular location of the vehicle, and the localized mapping outputs may be used by the world model manager 122 to generate and/or update the world model.

The planning component(s) 124 may include a route planner, a lane planner, a behavior planner, and a behavior selector, among other components, features, and/or functionality. The route planner may use the information from the map perceiver, the map manager, and/or the localization manger, among other information, to generate a planned path that may consist of GNSS waypoints (e.g., GPS waypoints), 3D world coordinates (e.g., Cartesian, polar, etc.) that indicate coordinates relative to an origin point on the vehicle, etc. The waypoints may be representative of a specific distance into the future for the vehicle, such as a number of city blocks, a number of kilometers, a number of feet, a number of inches, a number of miles, etc., that may be used as a target for the lane planner.

The lane planner may use the lane graph (e.g., the lane graph from the path perceiver), object poses within the lane graph (e.g., according to the localization manager), and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The behavior planner may determine the feasibility of basic behaviors of the vehicle, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) 126 may follow a trajectory or path (lateral and longitudinal) that has been received from the behavior selector (e.g., based on the path geometry(ies) and/or the classification(s)) of the planning component(s) 124 as closely as possible and within the capabilities of the vehicle. The control component(s) 126 may use tight feedback to handle unplanned events or behaviors that are not modeled and/or anything that causes discrepancies from the ideal (e.g., unexpected delay). In some examples, the control component(s) 126 may use a forward prediction model that takes control as an input variable, and produces predictions that may be compared with the desired state (e.g., compared with the desired lateral and longitudinal path requested by the planning component(s) 124). The control(s) that minimize discrepancy may be determined.

Although the planning component(s) 124 and the control component(s) 126 are illustrated separately, this is not intended to be limiting. For instance, in some example, the delineation between the planning component(s) 124 and the control component(s) 126 may not be precisely defined. As such, at least some of the components, features, and/or functionality attributed to the planning component(s) 124 may be associated with the control component(s) 126, and vice versa. This may also hold true for any of the separately illustrated components of the drive stack 120.

The obstacle avoidance component(s) 128 may aid the vehicle in avoiding collisions with objects (e.g., dynamic and stationary objects). The obstacle avoidance component(s) 128 may include a computational mechanism at a “primal level” of obstacle avoidance, and may act as a “survival brain” or “reptile brain” for the vehicle. In some examples, the obstacle avoidance component(s) 128 may be used independently of components, features, and/or functionality of the vehicle that is required to obey traffic rules and drive courteously. In such examples, the obstacle avoidance component(s) 128 may ignore traffic laws, rules of the road, and courteous driving norms in order to ensure that collisions do not occur between the vehicle and any objects. As such, the obstacle avoidance layer may be a separate layer from the rules of the road layer, and the obstacle avoidance layer may ensure that the vehicle is only performing safe actions from an obstacle avoidance standpoint. The rules of the road layer, on the other hand, may ensure that vehicle obeys traffic laws and conventions, and observes lawful and conventional right of way (as described herein).

In some examples, the drivable paths as defined by the path geometries and/or the path classification(s) corresponding to each of the path geometries may be used by the obstacle avoidance component(s) 128 in determining controls or actions to take. For example, the drivable paths may provide an indication to the obstacle avoidance component(s) 128 of where the vehicle may maneuver without striking any objects, structures, and/or the like, or at least where no static structures may exist. In some examples, the obstacle avoidance component(s) 128 may be implemented as a separate, discrete feature of the vehicle. For example, the obstacle avoidance component(s) 128 may operate separately (e.g., in parallel with, prior to, and/or after) the planning layer, the control layer, the actuation layer, and/or other layers of the drive stack 120.

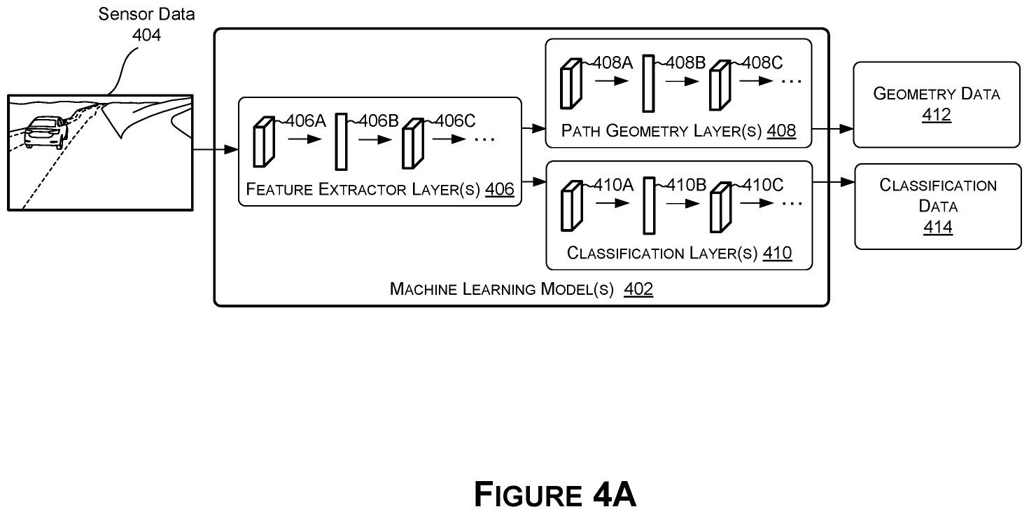

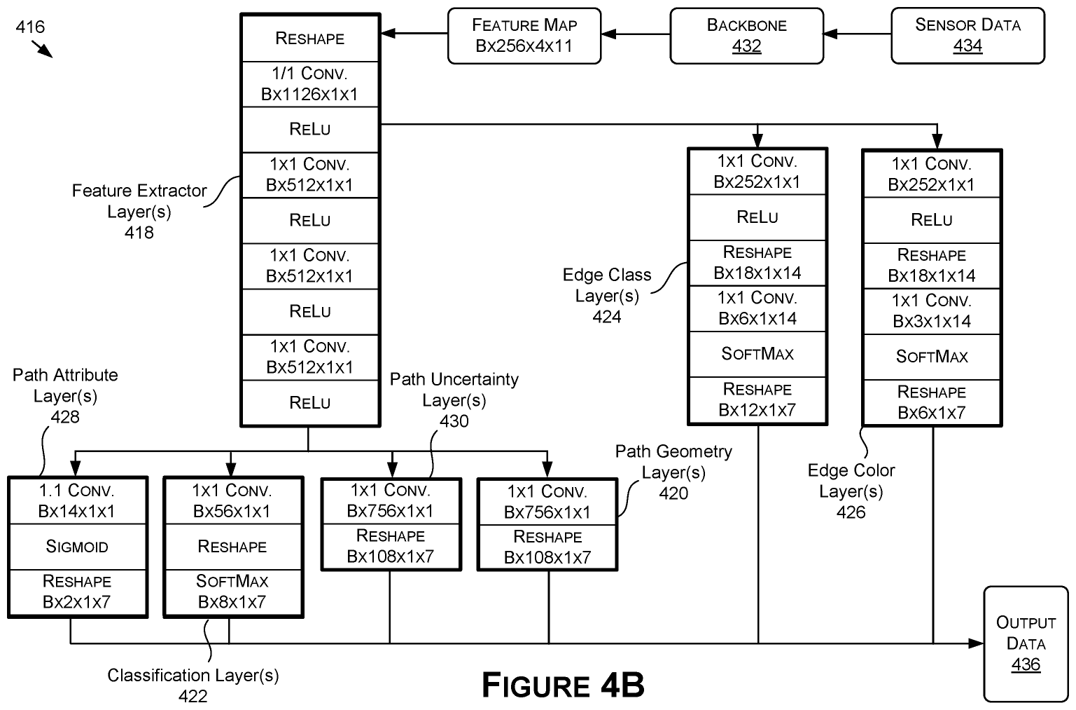

Now referring to FIG. 4A, FIG. 4A illustrates a first example of one or more machine learning models 402 configured to determine geometries associated with paths, in accordance with some embodiments of the present disclosure. The machine learning model(s) 402 may be one example of the machine learning model(s) 102 that may be used in the process 100 of FIG. 1. The machine learning model(s) 402 may include or be referred to as a convolutional neural network and thus may alternatively be referred to herein as convolutional neural network 402, convolutional network 402, or CNN 402.

As described herein, the machine learning model(s) 402 may use sensor data 404 (which may represent, and/or include, the sensor data 104) (with or without pre-processing) as an input. The sensor data 404 may represent images (e.g., the sensor data 404 may be image data) generated by one or more image sensors (e.g., one or more of the cameras of a vehicle). For example, the sensor data 404 may include image data representative of a field of view of the image sensor(s). More specifically, the sensor data 404 may include individual images generated by the image sensor(s), where image data representative of one or more of the individual images may be input into the machine learning model(s) 402 at each iteration of the machine learning model(s) 402. The sensor data 404 may be input as a single image, or may be input using batching, such as mini-batching. For example, two or more images may be used as inputs together (e.g., at the same time). The two or more images may be from two or more sensors (e.g., two or more image sensors) that captured the images at the same time.

The sensor data 404 may be input into one or more feature extractor layers 406 of the machine learning model(s) 402 (e.g., feature extractor layer 406A). The feature extractor layer(s) 406 may include any number of layers 406, such as the layers 406A-406C. One or more of the layers 406 may include an input layer. The input layer may hold values associated with the sensor data 404. For example, when the sensor data 404 is an image(s), the input layer may hold values representative of the raw pixel values of the image(s) as a volume (e.g., a width, W, a height, H, and color channels, C (e.g., RGB), such as 32×32×3), and/or a batch size, B (e.g., where batching is used)

One or more layers 406 may include convolutional layers. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters, such as 32×32×12, if 12 were the number of filters).

One or more of the layers 406 may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers 406 may include a pooling layer. The pooling layer may perform a down-sampling operation along the spatial dimensions (e.g., the height and the width), which may result in a smaller volume than the input of the pooling layer (e.g., 16×16×12 from the 32×32×12 input volume). In some examples, the machine learning model(s) 402 may not include any pooling layers. In such examples, strided convolution layers may be used in place of pooling layers. In some examples, the feature extractor layer(s) 406 may include alternating convolutional layers and pooling layers.

One or more of the layers 406 may include a fully connected layer. Each neuron in the fully connected layer(s) may be connected to each of the neurons in the previous volume. The fully connected layer may compute class scores, and the resulting volume may be 1×1×number of classes. In some examples, the feature extractor layer(s) 406 may include a fully connected layer, while in other examples, the fully connected layer of the machine learning model(s) 402 may be the fully connected layer separate from the feature extractor layer(s) 406. In some examples, no fully connected layers may be used by the feature extractor and/or the machine learning model(s) 402 as a whole, in an effort to increase processing times and reduce computing resource requirements. In such examples, where no fully connected layers are used, the machine learning model(s) 402 may be referred to as a fully convolutional network.

One or more of the layers 406 may, in some examples, include deconvolutional layer(s). However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input images (e.g., the sensor data 404) to the machine learning model(s) 402, or used to up-sample to the input spatial resolution of a next layer.

Although input layers, convolutional layers, pooling layers, ReLU layers, deconvolutional layers, and fully connected layers are discussed herein with respect to the feature extractor layer(s) 406, this is not intended to be limiting. For example, additional or alternative layers 406 may be used in the feature extractor layer(s) 406, such as normalization layers, SoftMax layers, and/or other layer types.

The output of the feature extractor layer(s) 406 may be an input into one or more path geometry layers 408 and/or one or more classification layers 410. The path geometry layer(s) 408 and/or the classification layer(s) 410 may use one or more of the layer types described herein with respect to the feature extractor layer(s) 406. As described herein, the path geometry layer(s) 408 and/or the classification layer(s) 410 may not include any fully connected layers, in some examples, to reduce processing speeds and decrease computing resource requirements. In such examples, the path geometry layer(s) 408 and/or the classification layer(s) 410 may be referred to as fully convolutional layers.

Different orders and numbers of the layers 406, 408, and 410 of the machine learning model(s) 402 may be used, depending on the embodiment. For example, where two or more image sensors or other sensor types are used to generate inputs, there may be a different order and number of layers 406, 408, and 410 for one or more of the sensors. As another example, different ordering and numbering of layers may be used depending on the type of sensor used to generate the sensor data 404, or the type of the sensor data 404 (e.g., RGB, YUV, etc.). In other words, the order and number of layers 406, 408, and 410 of the machine learning model(s) 402 is not limited to any one architecture.

In addition, some of the layers 406, 408, and 410 may include parameters (e.g., weights and/or biases)—such as the feature extractor layer(s) 406, the path geometry layer(s) 408, and/or the classification layer(s) 410—while others may not, such as the ReLU layers and pooling layers, for example. In some examples, the parameters may be learned by the machine learning model(s) 402 during training. Further, some of the layers 406, 408, and 410 may include additional hyper-parameters (e.g., learning rate, stride, epochs, kernel size, number of filters, type of pooling for pooling layers, etc.)—such as the convolutional layer(s), the deconvolutional layer(s), and the pooling layer(s)—while other layers may not, such as the ReLU layer(s). Various activation functions may be used, including but not limited to, ReLU, leaky ReLU, sigmoid, hyperbolic tangent (tanh), exponential linear unit (ELU), etc. The parameters, hyper-parameters, and/or activation functions are not to be limited and may differ depending on the embodiment.

In any example, the output of the machine learning model(s) 402 may include geometry data 412 (which may represent, and/or include the point data 106 and/or the path data 412) and classification data 414 (which may represent, and/or include, the classification data 108). In some examples, the path geometry layer(s) 408 may output the geometry data 412 and the classification layer(s) 410 may output the classification data 414. As such, the feature extractor layer(s) 406 may be referred to as a first convolutional stream, the path geometry layer(s) 408 may be referred to as a second convolutional stream, and/or the classification layer(s) 410 may be referred to as a third convolutional stream.

FIG. 4B illustrates a second example of one or more machine learning models 416 configured to determine geometries associated with paths, in accordance with some embodiments of the present disclosure. The machine learning model(s) 416 may be a non-limiting example of the machine learning model(s) 102 for use in the process 100 of FIG. 1. The machine learning model(s) 416 may be a convolutional neural network and thus may be referred to herein as convolutional neural network 416, convolutional network 416, or CNN 416. In some examples, the convolutional network 416 may include any number and type of different layers, although some examples do not include any fully connected layers in order to increase processing speeds and reduce computing requirements to enable the process 100.

The machine learning model(s) 416 may include one or more feature extractor layers 418, one or more path geometry layers 420, and/or one or more classification layers 422, which may correspond to the feature extractor layer(s) 406, the path geometry layer(s) 408, and/or the classification layer(s) 410 of FIG. 4A, respectively, in some examples. Additionally, the machine learning model(s) 416 may include one or more edge classification layers 424, one or more edge color layers 426, one or more path attribute layers 428, and/or one or more path uncertainty layers 430.

The feature extractor layer(s) 418 may include any number of layers, however, in some examples, the feature extractor layers 418 include less than a threshold number of layers (e.g., 9 layers, 18 layers, 25 layers, etc.) in order to minimize data storage requirements and to increase processing speeds for the machine learning model(s) 416. In some examples, the feature extractor layer(s) 418 may include at least convolutional layers that use 1×1 convolutions for one or more (e.g., each) of its layers, one or more reshape layers, and one or more rectified linear unit layers (ReLu layers). In addition, in some examples, the feature extractor layer(s) 418 may not include any skip-connections, which differs from conventional systems and may increase the processing times and accuracy of the system.

As shown, the feature extractor layer(s) 418 may take, as input, one or more feature maps generated by a backbone 432 that processes sensor data 434 (which may represent, and/or include, the sensor data 104). In some examples, the feature extractor layer(s) 418 may down sample the spatial resolution of the input image until the output layers are reached. The feature extractor layer(s) 418 may be trained to generate a hierarchical representation of the input image(s) (or other sensor data representations) received from the sensor data 434 with one or more layers (e.g., each layer) generating a higher-level extraction than its preceding layer. In other words, the input resolution across the feature extractor layer(s) 418 (and/or any additional or alternative layers) may be decreased, allowing the machine learning model(s) 416 to be capable of processing images faster than conventional systems.

The path geometry layer(s) 420, the classification layer(s) 422, the path attribute layer(s) 428, and/or the path uncertainty layer(s) 430 may take the output of the feature extractor layer(s) 418, or the output of one or more additional layers as input. The path geometry layer(s) 420 may be used to compute the locations associated with the points and/or the geometries associated with the paths. The classification layer(s) 422 may be used to compute confidence values corresponding to a likelihood or confidence that, for one or more (e.g., each) of the paths predicted by the path geometry layer(s) 420, the path corresponds to a classification (e.g., a path type). Additionally, the path attribute layer(s) 428 may be used to compute one or more attributes associated with the paths and the path uncertainty layer(s) 430 may be used to compute one or more uncertainties associated with the paths.

The path geometry layer(s) 420 may include at least a convolutional layer and a reshape layer. The classification layer(s) 422 may include at least a convolutional layer, a reshape layer, and a SoftMax layer. Additionally, the path attribute layer(s) 428 may include at least a convolutional layer, a Sigmoid layer, and a SoftMax layer. Furthermore, the path uncertainty layer(s) 430 may include at least a convolutional layer and a reshape layer. While these are just a few examples of what layers may be included in the path geometry layer(s) 420, the classification layer(s) 422, the path attribute layer(s) 428, and/or the path uncertainty layer(s) 430, in other examples, the path geometry layer(s) 420, the classification layer(s) 422, the path attribute layer(s) 428, and/or the path uncertainty layer(s) 430 may include any number and/or type of layers without departing from the scope of the present disclosure.

The edge class layer(s) 424 and/or the edge color layer(s) 426 may take the output from one or more layers, such as the ReLu layer, of the feature extractor layer(s) 418. The edge class layer(s) 424 may be used to compute one or more edge classes. Additionally, the edge color layer(s) 426 may be used to compute one or more edge color. The edge class layer(s) 424 may include convolutional layers, a ReLu Layer, reshape layers, and a SoftMax layer. Additionally, the edge color layer(s) 424 may include convolutional layers, a ReLu Layer, reshape layers, and a SoftMax layer. While these are just a few examples of what layers may be included in the edge class layer(s) 424 and the edge color layer(s) 426, in other examples, the edge class layer(s) 424 and/or the edge color layer(s) 426 may include any number or type of layers without departing from the scope of the present disclosure.

In some examples, the output (which may be represented by the output data 436) of the machine learning model(s) 416 may include the points, the path geometries, the classifications, the attributes, the uncertainties, the edge classes, and/or the edge colors. As an example, the output of the points may have a spatial resolution of P×C×N, where P is the number of points for each path, C is the number of coordinates associated with each point, and N is the number of paths determined by the machine learning model(s) 416. As described here, the number of points P for each path may include, but is not limited to, two points, five points, eight points, twelve points, twenty points, fifty points, and/or any other number of points. Additionally, the number of coordinates C associated with each point may include, but is not limited to, one coordinate (e.g., a delta value), two coordinates (e.g., the x-coordinate and the y-coordinate), three coordinates (e.g., the x-coordinate, the y-coordinate, and the z-coordinate), and/or so forth. Furthermore, the number of paths N may include, but is not limited to, one path, two paths, five paths, seven paths, ten paths, and/or any other number of paths.

In some examples, although not illustrated in FIG. 4B, the machine learning model(s) 416 may include one or more concatenation layers (e.g., depth concatenation layer(s)) that receive the outputs (e.g., outputs from at least the path geometry layer(s) 420, the classification layer(s) 422, the edge class layer(s) 424, the edge color layer(s) 426, the path attribute layer(s) 428, and/or the path uncertainty layer(s) 420) and concatenate them. For example, because the output spatial resolution of the path geometry layer(s) 420 and the classification layer(s) 422 may be the same along two dimensions (e.g., height and width), a depth concatenation layer(s) may be used to concatenate along the depth dimension (e.g., the channel dimension).

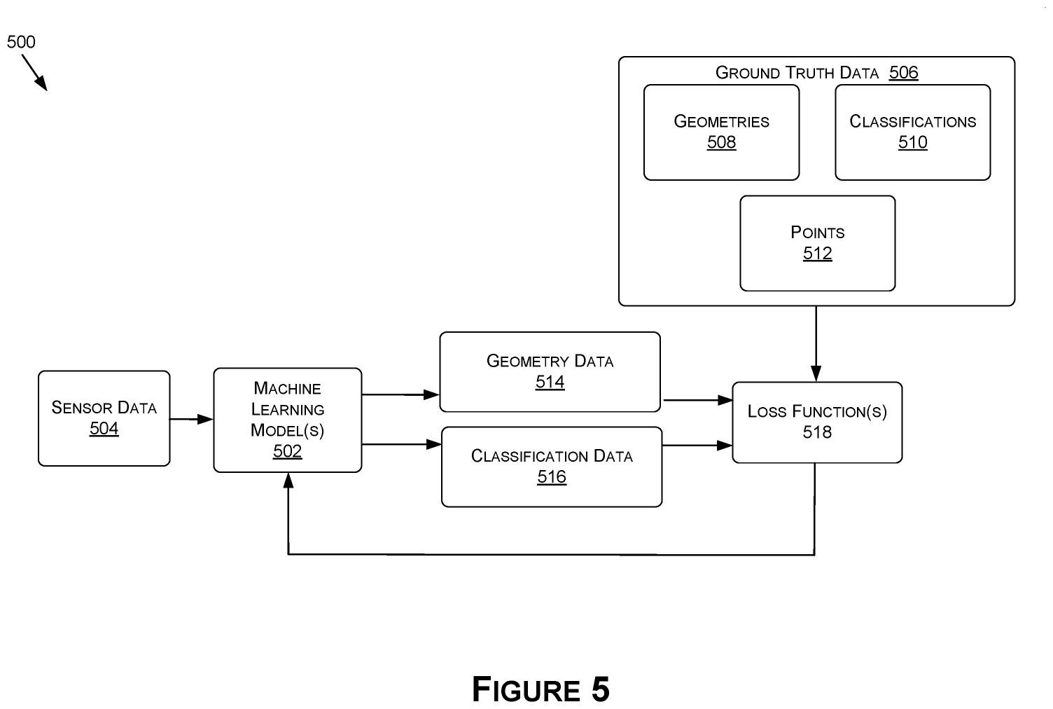

FIG. 5 is a data flow diagram illustrating a process 500 for training one or more machine learning model(s) 502 for path detection, in accordance with some embodiments of the present disclosure. In some examples, the machine learning model(s) 502 may represent, and/or include, the machine learning model(s) 102, the machine learning model(s) 402, and/or the machine learning model(s) 416. The machine learning model(s) 502 may be trained using sensor data 504 (which may represent, and/or include, the sensor data 104). In some examples, when used for training, the sensor data 504 may be referred to as training sensor data. Although the sensor data 504 is primarily discussed with respect to image data representative of one or more images, this is not intended to be limiting. For example, the sensor data 504 may include LiDAR data, RADAR data, and/or any other data generated using any other type of sensor.

The sensor data 504 used for training may include original images (e.g., as captured by one or more image sensors), down-sampled images, up-sampled images, cropped or region of interest (ROI) images, otherwise augmented images, and/or a combination thereof. The sensor data 504 may be images captured by one or more sensors (e.g., image sensors) of various vehicles and/or may be images captured from within a virtual environment used for testing and/or generating training images (e.g., a virtual camera of a virtual vehicle within a virtual or simulated). In some examples, the sensor data 504 may include images from a data store or repository of training images (e.g., images of driving surfaces). As shown, the machine learning model(s) 502 may be trained using the images (and/or other sensor data 504) as well as corresponding ground truth data 506. As described herein, the ground truth data 506 may include annotations, labels, masks, and/or the like.

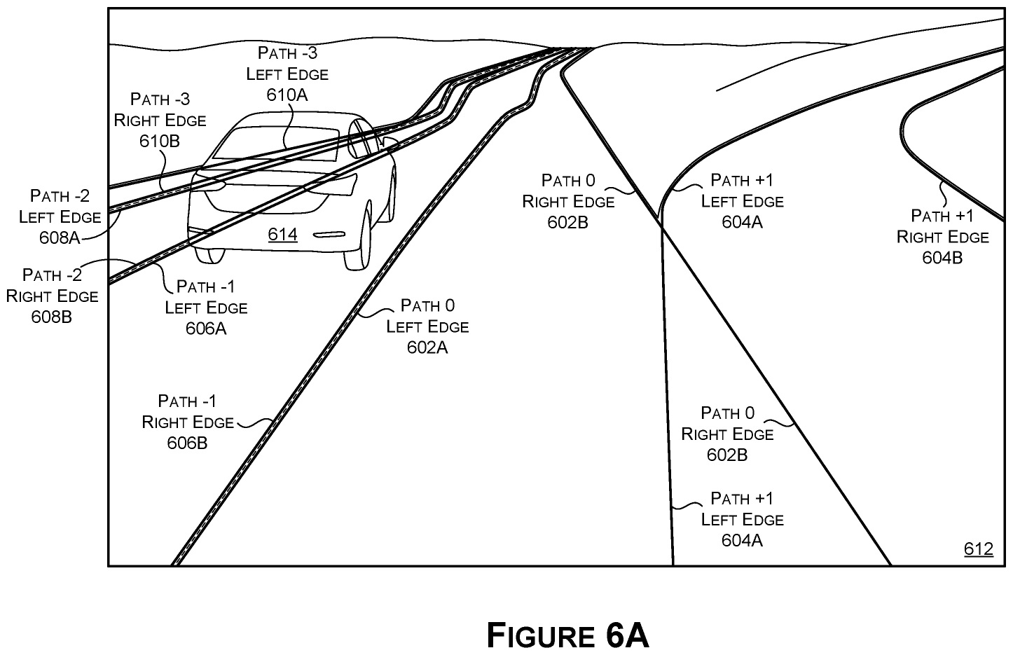

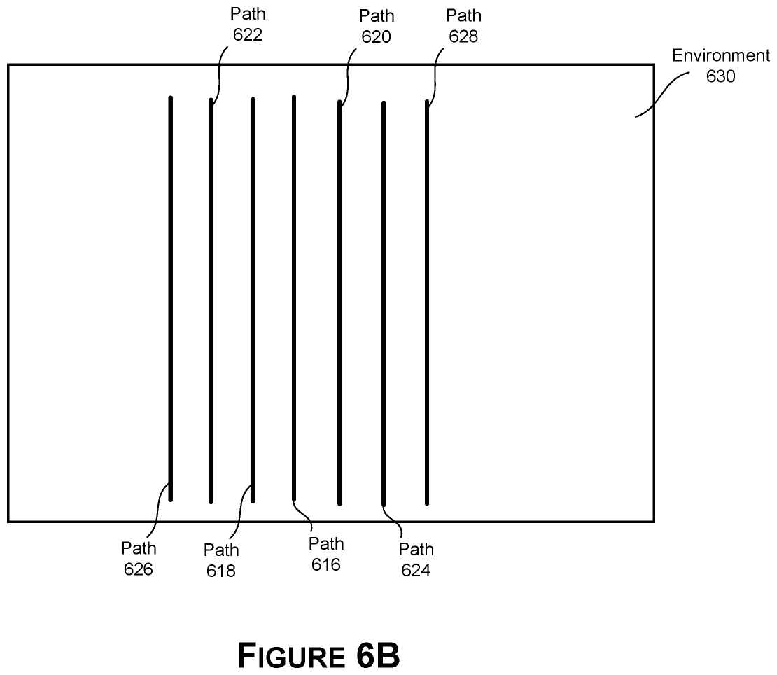

In some examples, the ground truth data 506 may include geometries 508 (e.g., curves, polylines, etc.) representing the paths and/or classifications 510 associated with the paths. For instance, FIG. 6A illustrates a first example of ground truth data representing geometries associated with paths, in accordance with some embodiments of the present disclosure. In the example of FIG. 6A, five paths may be annotated as the path labels-a vehicle path 602 (e.g., path 0), a right of vehicle path 604 (e.g., path+1), a first left of vehicle path 606 (e.g., path−1), a second left of vehicle path 608 (e.g., path−2), and a third left of vehicle path 610 (e.g., path−3). In some examples, the machine learning model(s) 502 may be trained to predict five path types, may be trained to predict seven path types (e.g., vehicle path, three to the left of vehicle path, and three to the right of vehicle path), or may be trained to predict any number of path type(s)). The five paths may correspond to an image 612 (e.g., may correspond to pixel locations of the image 612). The path label(s) may include edges of the paths, such that a left edge 602A and right edge 602B delineate the path 602, a left edge 604A and right edge 604B delineate the path 604, a left edge 606A and right edge 606B delineate the path 606, a left edge 608A and right edge 608B delineate the path 608, and a left edge 610A and right edge 610B delineate the path 610.

As illustrated in FIG. 6A, the annotations of the left edge 608A, the right edge 608B, the left edge 610A, the right edge 610B, and the left edge 606A extend along vehicle 614. As such, the machine learning model(s) 502 may be trained to predict drivable paths without relying on the existence of lane markings or road boundary lines (e.g., even where lane marking or road boundary lines are occluded by a vehicle or other object).

As further illustrated in FIG. 6A, the annotations of the right edge 602B and the left edge 604A are included in an area where lane markings are not present (e.g., where the driving surface splits for an exit, or offramp). However, the path labels are included to extend beyond where lane markings or road boundaries may exist, such that the machine learning model(s) 502 may be trained to predict paths (e.g., as path geometries) that extend continuously in space (e.g., that extend not only along regions where lane markings or road boundaries would conventionally exist). As a result, the drivable paths may be defined along regions of the drivable surface where no visible delineation is present.

FIG. 6B illustrates a second example of ground truth data representing geometries associated with paths, in accordance with some embodiments of the present disclosure. In the example of FIG. 6B, seven paths may be annotated with labels, vehicle path 616 (e.g., path 0), first left of vehicle path 618 (e.g., path−1), first right of vehicle path 620 (e.g., path+1), second left of vehicle path 622 (e.g., path−2), second right of vehicle path 624 (e.g., path+2), third left of vehicle path 626 (e.g., path−3), and third right of vehicle path 628 (e.g., path+3). However, in other examples, any number of paths may be annotated. Additionally, in the example of FIG. 6B, the paths are annotated with respect to a 3D world space, such as that the paths are associated with an environment 630.

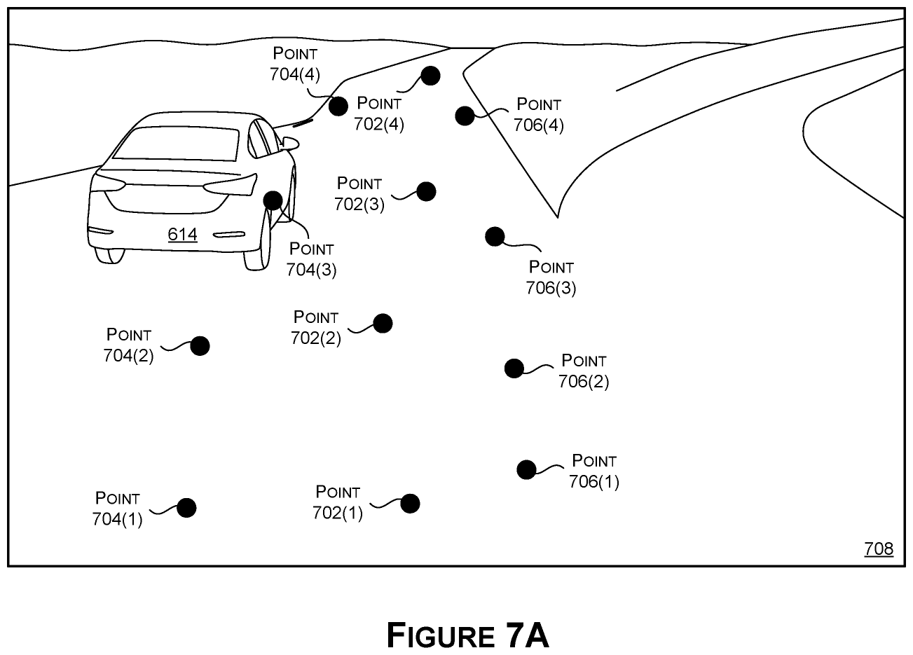

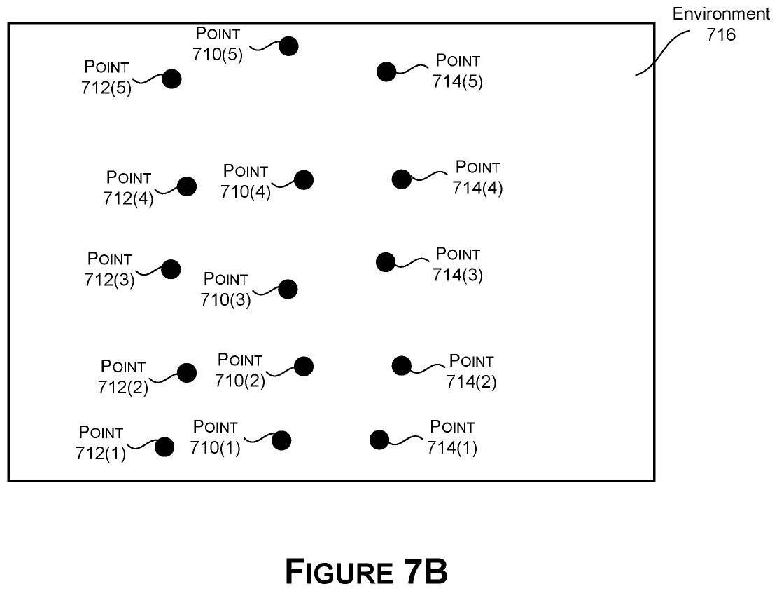

Referring back to the example of FIG. 5, in addition to, or alternatively from, the ground truth data 506 representing the geometries 508 associated with the paths, the ground truth data 506 may represent points 512 (e.g., control or Bezier points) associated with the paths. For instance, FIG. 7A illustrates a first example of ground truth data representing points associated with paths, in accordance with some embodiments of the present disclosure. In the example of FIG. 7A, points for three paths may be annotated as the path labels-points 702(1)-(4) associated with a vehicle path (e.g., path 0), points 704(1)-(4) associated with a left of vehicle path (e.g., path−1), and points 706(1)-(4) associated with a right of vehicle path (e.g., path+1). While the example of FIG. 7A only illustrates annotating points for three paths for an image 708, in other examples, points for any number of paths may be annotated. Additionally, while the example of FIG. 7A only illustrates annotating four points per path, in other examples, any number of (one or more) points may be annotated for each path.

FIG. 7B illustrates a second example of ground truth data representing points associated with paths, in accordance with some embodiments of the present disclosure. In the example of FIG. 7B, points for three paths may again be annotated as the path labels-points 710(1)-(5) associated with a vehicle path (e.g., path 0), points 712(1)-(5) associated with a left of vehicle path (e.g., path−1), and points 714(1)-(5) associated with a right of vehicle path (e.g., path+1). While the example of FIG. 7B only illustrates annotating points for three paths within a 3D world space associated with an environment 716, in other examples, points for any number of paths may be annotated. Additionally, while the example of FIG. 7B only illustrates annotating four points per path, in other examples, any number of points may be annotated for each path.

Referring back to the example of FIG. 5, the ground truth data 506 may be generated within a drawing program (e.g., an annotation program), a computer aided design (CAD) program, a labeling program, another type of program suitable for generating the ground truth data 506, and/or may be hand drawn, in some examples. In any example, the ground truth data 506 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, for each input image, there may be corresponding ground truth data 506.

The machine learning model(s) 502 may perform forward pass computations on the sensor data 504 (e.g., before or after augmentation and/or before or after pre-processing). As described herein, the machine learning model(s) 502 may thus generate geometry data 514 and classification data 516 associated with paths associated with the sensor data 504. The geometry data 514 may be similar to the point data 106 and/or the path data 112. For a first example, such as when the ground truth data 506 represents the points 512 (e.g., Bezier points), the geometry data 514 may represent points (e.g., Bezier points) associated with one or more paths for one or more sensor representations (e.g., each image) represented by the sensor data 504. For a second example, such as when the ground truth data 506 represents the geometries (e.g., Bezier curves), the geometry data 514 may represent one or more geometries (e.g., one or more Bezier curves) associated with the path(s) for the sensor representation(s) represented by the sensor data 504. The classification data 516 may be similar to the classification data 108. For example, the classification data 516 may represent one or more classifications associated with the path(s) for the sensor representation(s) represented by the sensor data 504.

As further illustrated by the example of FIG. 5, one or more loss functions 518 may be used to measure loss (e.g., error) in the outputs (e.g., predictions generated by the machine learning model(s) 502) as compared to the ground truth data 506. Any type of loss function may be used, such as cross entropy loss, mean squared error, mean absolute error, mean bias error, and/or other loss function types. In some examples, different outputs (e.g., predicted points, predicted path geometries, predicted classifications, etc.) may have different loss functions. For example, the path geometries predicted by the machine learning model(s) 502 may use a first loss function and the classifications may use a second loss function (e.g., different from the first loss function). In such examples, the loss functions may be combined to form a total loss, and the total loss may be used to train (e.g., update the parameters of) the machine learning model(s) 502. In any example, backward pass computations may be performed to recursively compute gradients of the loss function(s) 518 with respect to training parameters. In some examples, weight and biases of the machine learning model(s) 502 may be used to compute these gradients.

For example, a geometry loss may try to minimize L1 distances between ground truth geometries (e.g., ground truth polylines) and predicted geometries (e.g., predicted polylines). For instance, the geometry loss may include:

L_{3D}(\hat{γ},γ)=1/nΣᵢ₌₁ⁿ|\hat{γ}ᵢ−γᵢ|/σₚᵣ+|\hat{γ}ᵢ−γᵢ|/σᵢ+log 2σᵢ (4)

In equation (4), \hat{γ} is the ground truth geometry, γ is the predicted geometry, | | denotes the L1 norm, n is the total number of points associated with the geometry, σₚᵣ is a prior uncertainty, and σᵢ is a predicted uncertainty. In some examples, there is an assumed noise, such as 10% (and/or any other percentage in other examples).

In some examples, such as to further improve the accuracy and/or robustness of the prediction, a curvature-based regularization term may be added to the geometric loss, such as:

$${ℒ}_{3 D} ( \hat{y} , y ) = {ℒ}_{3 D} ( \hat{y} , y ) + λ \qquad ( 5 )$$

In equation (5), [symbol] may include a regulation term and λ may include a hyper parameter that control a balance between the two terms. In some examples, the regularization may help constrain possible shapes geometries, and smooth out any sudden changes or noise in the predicted geometries. As such, the curvature of a geometry may be defined by the following:

$$= \frac{{f}_{x}^{′} {f}_{y}^{″} - {f}_{y}^{′} {f}_{x}^{″}}{{( {f}_{x}^{′2} + {f}_{y}^{′2} )}^{\frac{3}{2}}} \qquad ( 6 )$$

In equation (6), x, y are the coordinates of a point on a geometry.

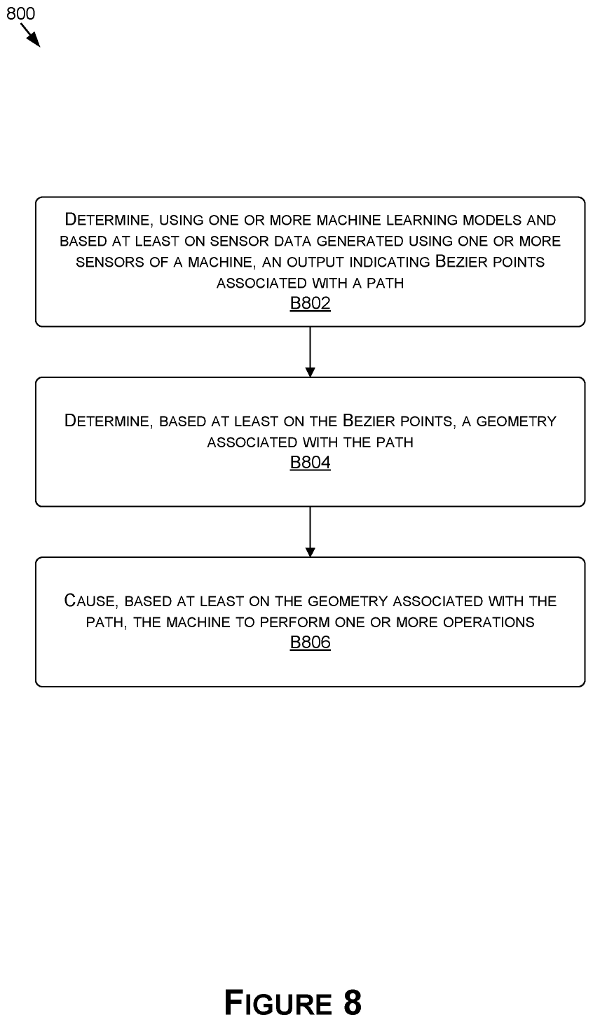

Now referring to FIG. 8, each block of method 800, described herein, comprises a computing process that may be performed using any combination of hardware, firmware, and/or software. For instance, various functions may be carried out by a processor executing instructions stored in memory. The method 800 may also be embodied as computer-usable instructions stored on computer storage media. The method 800 may be provided by a standalone application, a service or hosted service (standalone or in combination with another hosted service), or a plug-in to another product, to name a few. In addition, the method 800 is described, by way of example, with respect to FIG. 1. However, the method 800 may additionally or alternatively be executed by any one system, or any combination of systems, including, but not limited to, those described herein.

FIG. 8 illustrates a flow diagram showing a method 800 for determining a Bezier curve associated with a path of a machine, in accordance with some embodiments of the present disclosure. The method 800, at block B802, may include determining, using one or more machine learning models and based at least on sensor data generated using one or more sensors of a machine, an output indicating Bezier points associated with a path. For instance, the sensor data 104 may be input into the machine learning model(s) 102. The machine learning model(s) 102 may then process the sensor data 104 and, based at least on the processing, output the point data 106 representing the Bezier points associated with the path. In some examples, the machine learning model(s) 102 may output additional data, such as the classification data 108 representing the classification associated with the Bezier points and/or the path.

The method 800, at block B804, may include determining, based at least on the Bezier points, a geometry associated with the path. For instance, the machine learning model(s) 102 and/or the path component 110 (which may include one or more layers of the machine learning model(s) 102) may process the point data 106 and, based at least on the processing, output the path data 112 representing the geometry associated with the path. In some examples, the geometry may include a Bezier curve associated with the path. For instance, in some examples, the machine learning model(s) 102 and/or the path component 110 may determine the geometry using one or more Bezier algorithms.

The method 800, at block B806, may include causing, based at least on the geometry associated with the path, the machine to perform one or more operations. For instance, the drive stack 120 may cause the machine to perform the one or more operations based at least on the geometry associated with the path, such as to navigate along the path. Additionally, in some examples, while the process 800 is described with respect to generating a single path, in some examples, the process 800 may include generating multiple paths.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to enable the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to enable autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation enabling any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LiDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 912 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to enable communication with peripherals, audio codecs, power management, and/or other devices. The SoC(s) 904 may be used to process data from cameras (e.g., connected over Gigabit Multimedia Serial Link and Ethernet), sensors (e.g., LiDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LiDAR sensor(s) 964. The LiDAR sensor(s) 964 may be used for object and pedestrian detection, emergency braking, collision avoidance, and/or other functions. The LiDAR sensor(s) 964 may be functional safety level ASIL B. In some examples, the vehicle 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900 m, with an accuracy of 2 cm-3 cm, and with support for a 900 Mbps Ethernet connection, for example. In some examples, one or more non-protruding LiDAR sensors 964 may be used. In such examples, the LiDAR sensor(s) 964 may be implemented as a small device that may be embedded into the front, rear, sides, and/or corners of the vehicle 900. The LiDAR sensor(s) 964, in such examples, may provide up to a 120-degree horizontal and 35-degree vertical field-of-view, with a 200 m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LiDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(H) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161 (N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116 (N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using one or more machine learning models and based at least on sensor data generated using one or more sensors of a machine, an output indicating Bezier points associated with a path;
determining, based at least on the Bezier points, a geometry associated with the path; and
causing, based at least on the geometry associated with the path, the machine to perform one or more operations.

2. The method of claim 1, wherein:
a first point, of the Bezier points, is located at a first location on the geometry that is associated with a start of the path;
a second point, of the Bezier points, is located at a second location on the geometry that is associated with an end of the path; and
a third point, of the Bezier points, is located at a third location that is outside of the geometry.

3. The method of claim 1, wherein the determining the geometry associated with the path uses at least one of:
the one or more neural networks; or
one or more Bezier algorithms.

4. The method of claim 1, further comprising:
determining, using the one or more machine learning models and based at least on the sensor data, a second output indicating a classification associated with the path,
wherein the causing the machine to perform the one or more operations is further based at least on the classification.

5. The method of claim 1, further comprising:
determining, the using one or more machine learning models and based at least on the sensor data, a second output indicating second Bezier points associated with a second path; and
determining, based at least on the second Bezier points, a second geometry associated with the second path,
wherein the causing the machine to perform the one or more operations is further based at least the second geometry associated with the second path.

6. The method of claim 4, wherein:
the path is associated with a current path that the machine is to navigate; and
the second path is associated with at least one of a right edge associated with the current path or a left edge associated with the current path.

7. The method of claim 1, wherein an individual Bezier point, of the Bezier points, is associated with at least one:
a two-dimensional location associated with a sensor representation represented by the sensor data; or
a three-dimensional location associated with an environment in which the machine is navigating.

8. The method of claim 1, wherein the sensor data is generated using the one or more sensors at a first time, and wherein the method further comprises:
determining, using the one or more machine learning models and based at least on second sensor data generated using the one or more sensors at a second time, a second output indicating second Bezier points associated with a second path;
determining, based at least on the second Bezier points, a second geometry associated with the second path; and
determine, based at least on the geometry associated with the path and the second geometry associated with the second path, a third geometry associated with the path,
wherein the causing the machine to perform the one or more operations is based at least on the third geometry associated with the path.

9. A system comprising:
one or more processing units to:
determine, using one or more machine learning models and based at least on sensor data generated using one or more sensors of a machine, an output indicating points associated with a path;
determine, based at least on the points, a Bezier curve associated with the path; and
cause, based at least on the Bezier curve associated with the path, the machine to perform one or more operations.

10. The system of claim 9, wherein:
a first point, of the points, is located at a first location on the Bezier curve that is associated with a start of the path;
a second point, of the points, is located at a second location on the Bezier curve that is associated with an end of the path; and
a third point, of the points, is located at a third location that is outside of the Bezier curve.

11. The system of claim 9, wherein the one or more processing units are further to:
determine, using the one or more machine learning models and based at least on the sensor data, a second output indicating a classification associated with the path,
wherein the machine is further caused to perform the one or more operations based at least on the classification.

12. The system of claim 9, wherein the one or more processing units are further to:
determine, the using one or more machine learning models and based at least on the sensor data, a second output indicating second points associated with a second path; and
determine, based at least on the second points, a second Bezier curve associated with the second path,
wherein the machine is further caused to perform the one or more operations based at least the second geometry associated with the second path.

13. The system of claim 12, wherein:
the path is associated with a current path that the machine is to navigate; and
the second path is associated with at least one of a right edge associated with the current path or a left edge associated with the current path.

14. The system of claim 9, wherein an individual point, from the points, is associated with at least one:
a two-dimensional location associated with a sensor representation represented by the sensor data; or
a three-dimensional location associated with an environment in which the machine is navigating.

15. The system of claim 9, wherein the one or more processing units are further to:
generate, based at least on a second Bezier curve associated with a second path, an updated curve associated with the path by smoothing at least a portion of the Bezier curve associated with the path,
wherein the machine is caused to perform the one or more operations based at least on the update curve associated with the path.

16. The system of claim 9, wherein the determination of the Bezier curve associated with the path uses one or more of a two-dimensional Bezier curve fitting algorithm, a three-dimensional Bezier curve fitting algorithm, a cubic Bezier curve fitting algorithm, a higher order Bezier curve fitting algorithm, or a split wise Bezier curve fitting algorithm.

17. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

18. A processor comprising:
one or more processing units to cause a machine to perform one or more operations based at least on a curve associated with a path for the machine, wherein the curve is determined using one or more regressed control points determined based at least on one or more machine learning models processing sensor data obtained using one or more sensors of the machine.

19. The processor of claim 18, wherein the determination of the curve comprises:
determining, using the one or more machine learning models and based at least on the sensor data, the one or more regressed control points associated with the path; and
determining, using the one or more machine learning models and based at least on the one or more regressed control points, the curve associated with the path.

20. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center, or
a system implemented at least partially using cloud computing resources.
